(19) United States
(12) Patent Application Publication
(10) Pub. No.: US 2009/0003246 A1
(43) Pub. Date: Jan. 1, 2009

(54) Multimedia conference device

(75) Inventors: Chin-Hao Hung, Suhih City (TW); Tien-Hao Yang, Suhih City (TW)

Correspondence Address: Joe McKinney Muncy, PO Box 1364, Fairfax, VA, 22038-1364, US

(73) Assignee: BEHAVIOR TECH COMPUTER CORP.

(21) Appl. No.: 12/000,268

(22) Filed: Dec. 11, 2007

(30) Foreign Application Priority Data
Jun. 26, 2007 (TW) 96210399

(51) Int. Cl. H04L 12/16

(52) U.S. Cl. 370/260

(57) ABSTRACT

A multimedia conference device includes a main body, at least three legs, and a cylindrical portion. At least three legs are pivotally connected with the main body respectively at one end thereof. The cylindrical portion extends outward from a central area of the main body.

### RELATED APPLICATIONS

This application claims priority to Taiwan Application Serial Number 96210399, filed Jun. 26, 2007, which is herein incorporated by reference.

### BACKGROUND

1. Field of Invention

The present invention relates to a multimedia conference device.

2. Description of Related Art

As web instant communication technologies develop rapidly, more and more business companies choose IP-based communication software, such as Skype, as their major conference communication tool. A multimedia conference device equipped with all necessary functions is in demand in present market.

### SUMMARY

It is therefore an objective of the present invention to provide a multimedia conference device.

In accordance with the foregoing and other objectives of the present invention, a multimedia conference device includes a main body, at least three legs, and a cylindrical portion. At least three legs are respectively pivotally connected with the main body at one end thereof. The cylindrical portion extends outward from a central area of the main body.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 illustrates a top view of a multimedia conference device as described in an embodiment herein; and

FIG. 2 illustrates a bottom view of a multimedia conference device as three legs thereof are folded.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

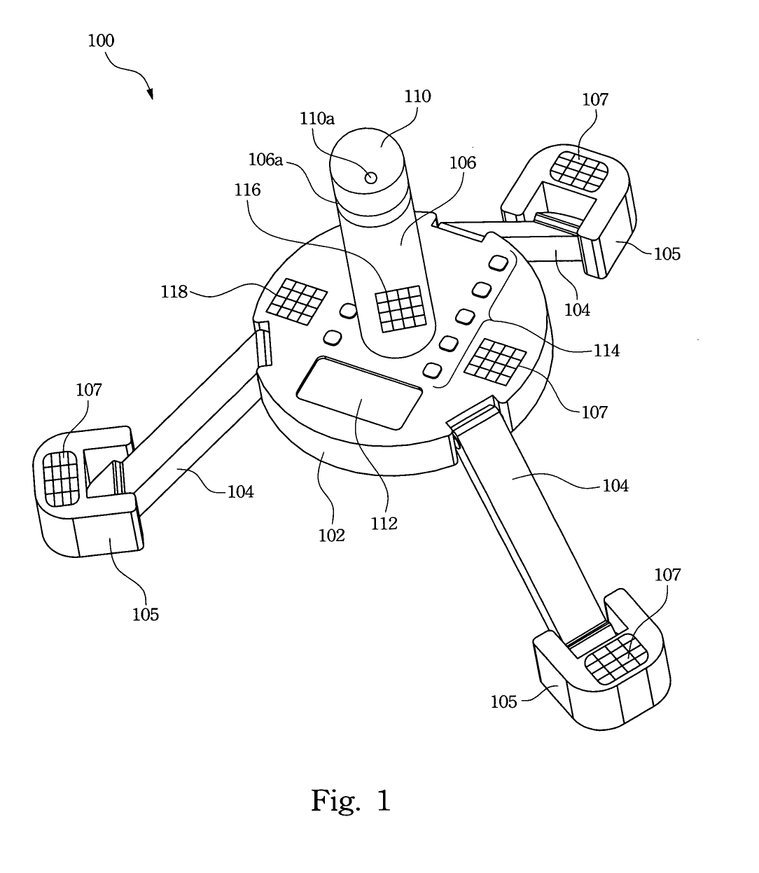

FIG. 1 illustrates a top view of a multimedia conference device as described in an embodiment herein. The multimedia conference device 100 includes a main body 102 of circular disk shape. The main body 102 is equipped with a flat panel display 112 (such as a liquid crystal display), several buttons 114 and a microphone 107. Users may dial phone number by means of the buttons 114 or input data to operate the multimedia conference device 100. The flat panel display 112 may display the number users dial or what users input. User's voice is converted into electrical signals by the microphone 107.

The multimedia conference device 100 further includes a cylindrical portion 106, extending vertically from a central area of the main body 102's top surface. A top end of the cylindrical portion 106 may be equipped with a camera 110. The camera 110 is pivotally connected with the cylindrical portion 106, such that the camera 110 can rotate relative to the cylindrical portion 106 and would thus reach larger region to shot images during a conference. The cylindrical portion 106 may be equipped with a colorful light emitting diode 106a to display an operating status (such as microphone 107 turns on or turns off) of the multimedia conference device 100. In an alternate embodiment, the camera 110 is detachably connected to the top end of the cylindrical portion 106 by a connector (such a USB connector), such that the idle camera 110 may be removed from the cylindrical portion 106.

The multimedia conference device 100 may further includes at least three legs 104 and at least three pedestals 105. Each leg 104 is pivotally connected with a circular boundary of the main body 102 at one end, and pivotally connected with each pedestal 105 at an opposite end. When the pedestals 105 are adjusted in position (closer or farther to the main body 102), the main body 102 and the camera 110 are elevated to a different level or degree such that the camera 110 would thus reach a larger region to shot images during a conference.

The multimedia conference device 100 may further includes microphones and speakers, which are located either in the main body 102, the cylindrical portion 106 or the pedestals 105 according to demands. In present embodiment, the microphones 107 are located on the pedestals 105 or the main body 102; the speaker 118 is located on the main body 102 and the speaker 116 is located on the cylindrical portion 106.

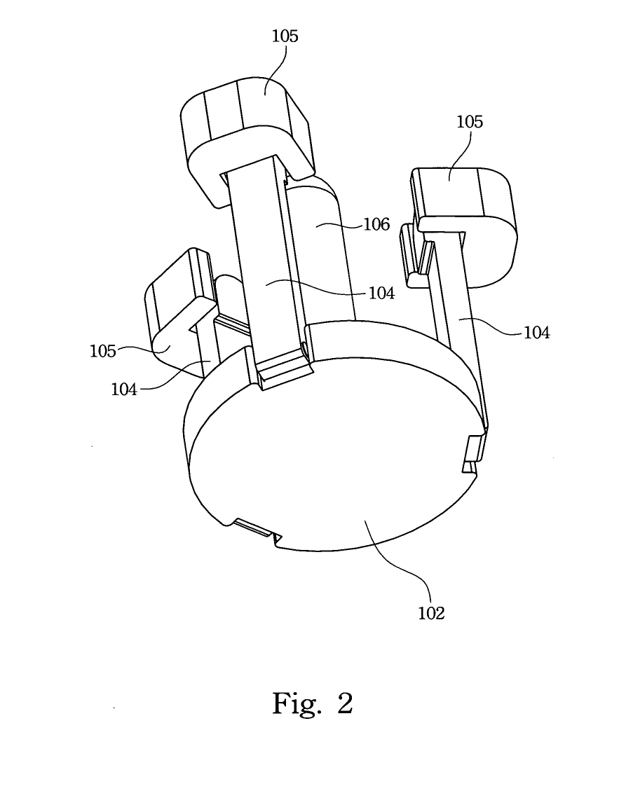

FIG. 2 illustrates a bottom view of a multimedia conference device as three legs thereof are folded. When the multimedia conference device 100 is idle or turns off, the legs 104 are folded to be perpendicular to the top surface of the main body 102 and the pedestals 105 are located around the camera 110 (as illustrated in FIG. 2). Therefore, the multimedia conference device 100 would occupy a compact space as a whole for easy storage.

According to embodiments discussed above, the multimedia conference device is equipped with a camera, microphones and speaker so as to perform all desired functions during a conference. In addition, the multimedia conference device has foldable legs to adjust its camera to a different height and would occupy a compact space when all legs are folded.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A multimedia conference device, comprising:
a main body;
at least three legs, pivotally connected with the main body respectively at one end thereof; and
a cylindrical portion, extending outward from a central area of the main body.

2. The multimedia conference device of claim 1, wherein the main body is of circular disk shape.

3. The multimedia conference device of claim 1, wherein the main body comprises a light emitting diode.

4. The multimedia conference device of claim 1, further comprising a flat panel display on the main body.

5. The multimedia conference device of claim 1, further comprising a speaker on the cylindrical portion.

6. The multimedia conference device of claim 1, further comprising a speaker on the main body.

7. The multimedia conference device of claim 1, wherein the cylindrical portion extends vertically from a top surface of the main body.

8. The multimedia conference device of claim 1, further comprising at three pedestals, respectively pivotally connected with an opposite end of each of the legs.

9. The multimedia conference device of claim 1, further comprising a microphone on the cylindrical portion.

10. The multimedia conference device of claim 1, further comprising a microphone on the main body.

11. A multimedia conference device, comprising:
a main body, comprising a plurality of buttons;
at least three legs, pivotally connected with the main body respectively at one end thereof;
a cylindrical portion, extending outward from a central area of the main body; and
a camera, pivotally connected on a top end of the cylindrical portion, such that the camera rotates relative to the cylindrical portion.

12. The multimedia conference device of claim 11, wherein the main body is of circular disk shape.

13. The multimedia conference device of claim 11, wherein the main body comprises a light emitting diode.

14. The multimedia conference device of claim 11, further comprising a flat panel display on the main body.

15. The multimedia conference device of claim 11, further comprising a speaker on the cylindrical portion.

16. The multimedia conference device of claim 11, further comprising a speaker on the main body.

17. The multimedia conference device of claim 11, wherein the cylindrical portion extends vertically from a top surface of the main body.

18. The multimedia conference device of claim 11, further comprising at least three pedestals, respectively pivotally connected with an opposite end of each of the legs.

19. The multimedia conference device of claim 11, further comprising a microphone on the cylindrical portion.

20. The multimedia conference device of claim 11, further comprising a microphone on the main body.
